(19) United States
(12) Patent Application Publication
(10) Pub. No.: US 2026/0155276 A1
(43) Pub. Date: Jun. 4, 2026

(54) QUANTUM OBJECT SHELVING USING ADIABATIC RAPID PASSAGE TRANSITIONS

(71) Applicant: Quantinuum LLC, Broomfield, CO (US)

(72) Inventor: Robert Tyler SUTHERLAND, San Antonio, TX (US)

(21) Appl. No.: 18/975,121

(22) Filed: Dec. 10, 2024

Related U.S. Application Data
(60) Provisional application No. 63/624,428, filed on Jan. 24, 2024.

(51) Int. Cl. G21K 1/20

(52) U.S. Cl. CPC G21K 1/20

(57) ABSTRACT

A controller causes performance of a shelving operation by causing a manipulation source to provide a manipulation signal characterized by a frequency and amplitude. The frequency is detuned from a transition frequency corresponding to a transition between a first quantum state and second quantum state of a quantum object. The detuning is an initial detuning and the amplitude is an initial amplitude. The manipulation signal is incident on the quantum object. The controller controls operation of the manipulation source to cause the detuning of the manipulation signal to evolve from the initial detuning to a zero detuning and the amplitude to increase from the initial amplitude to a maximum amplitude. The controller then controls operation of the manipulation source to cause the detuning of the manipulation signal to evolve from the zero detuning to a final detuning and the amplitude to decrease from the maximum amplitude to a final amplitude.

### CROSS-REFERENCE TO RELATED APPLICATION(S)

This Application claims priority to U.S. Application No. 63/624,428, filed Jan. 24, 2024, the content of which is incorporated herein by reference in its entirety.

### TECHNICAL FIELD

Various embodiments relate to shelving quantum objects in magnetic field insensitive state into magnetic field sensitive states. For example, various embodiments relate to shelving quantum objects using an adiabatic rapid passage transition into magnetic field sensitive states using integrated circuits with giga-Hertz (GHz) frequency alternating current (AC) currents.

### BACKGROUND

In various scenarios, it is desirable to shelf quantum objects. For example, confined quantum objects may be shelved from magnetic field insensitive states into magnetic field sensitive states for performance of a magnetic field mediated interactions. In another example, a confined quantum object may be shelved during performance of a state detection or measurement operation. Through applied effort, ingenuity, and innovation many deficiencies of conventional shelving techniques have been solved by developing solutions that are structured in accordance with the embodiments of the present invention, many examples of which are described in detail herein.

### BRIEF SUMMARY OF EXAMPLE EMBODIMENTS

Example embodiments provide methods, systems, apparatuses, computer program products and/or the like for performing shelving operations. During a shelving operation a quantum object is transitioned from a first sub-space of the energy space of the quantum object into a second sub-space of the energy space of the quantum object. For example, the first sub-space may be a qubit sub-space comprising magnetic field insensitive states (e.g., clock states) and the second sub-space may comprise magnetic field sensitive states. In various embodiments, the shelving transition (e.g., from the first sub-space to the second sub-space) or a deshelving transition (e.g., from the second sub-space to the first sub-space) is performed using an adiabatic rapid transition.

In an example embodiment, a controller is configured to control operation of a confinement apparatus configured to confine one or more quantum objects and one or more manipulation sources to cause performance of a shelving operation on at least one of the one or more quantum objects. To perform the shelving operation, the controller causes a manipulation source to provide a manipulation signal characterized by a frequency and an amplitude. The frequency is detuned by a detuning from a transition frequency corresponding to a transition between a first quantum state of a quantum object and a second quantum state of the quantum object. The detuning is an initial detuning and the amplitude is an initial amplitude. The manipulation signal is caused to be incident on the quantum object. The controller controls operation of the manipulation source to cause the detuning of the manipulation signal to evolve from the initial detuning to a zero detuning such that the frequency characterizing the manipulation signal is equal to the transition frequency and, simultaneously, to cause the amplitude to increase from the initial amplitude to a maximum amplitude. The controller then controls operation of the manipulation source to cause the detuning of the manipulation signal to evolve from the zero detuning to a final detuning and, simultaneously, to cause the amplitude to decrease from the maximum amplitude to a final amplitude. When the shelving operation is completed the at least one quantum object that was previously in the first quantum state has been shelved to the second quantum state.

According to one aspect, a method of performing a shelving operation is provided. In an example embodiment, the method is performed by a controller configured to control operation of a confinement apparatus and one or more manipulation sources. In an example embodiment, the method includes causing a manipulation source to provide a manipulation signal characterized by a frequency and an amplitude. The frequency is detuned by a detuning from a transition frequency corresponding to a transition between a first quantum state of a quantum object and a second quantum state of the quantum object. The detuning is an initial detuning and the amplitude is an initial amplitude. The manipulation signal is caused to be incident on the quantum object. The method further includes controlling operation of the manipulation source to cause the detuning of the manipulation signal to evolve from the initial detuning to a zero detuning such that the frequency characterizing the manipulation signal is equal to the transition frequency and, simultaneously, to cause the amplitude to increase from the initial amplitude to a maximum amplitude. The method further includes controlling operation of the manipulation source to cause the detuning of the manipulation signal to evolve from the zero detuning to a final detuning and, simultaneously, to cause the amplitude to decrease from the maximum amplitude to a final amplitude.

In an example embodiment, the initial detuning and the final detuning have opposite signs.

In an example embodiment, the initial detuning and the final detuning are equal in magnitude and have opposite signs.

In an example embodiment, the frequency is a microwave frequency.

In an example embodiment, a time period over which the detuning is evolved from the initial detuning to the zero detuning and the amplitude is increased from the initial amplitude to the maximum amplitude is longer than an inverse of a Rabi frequency of the transition.

In an example embodiment, the detuning is evolved from the initial detuning to the zero detuning and the amplitude is increased from the initial amplitude to the maximum amplitude adiabatically.

In an example embodiment, a time period over which the detuning is evolved from the zero detuning to the final detuning and the amplitude is decreased from the maximum amplitude to the final amplitude is longer than an inverse of a Rabi frequency of the transition.

In an example embodiment, the detuning is evolved from the zero detuning to the final detuning and the amplitude is decreased from the maximum amplitude to the final amplitude adiabatically.

In an example embodiment, a time period over which the detuning is evolved from the initial detuning to the zero detuning and then to the final detuning and the amplitude is increased from the initial amplitude to the maximum amplitude and then decreased from the maximum amplitude to the final amplitude is longer than an inverse of a Rabi frequency of the transition.

In an example embodiment, one of the first quantum state or the second quantum state is a magnetic field insensitive state and the other of the first quantum state or the second quantum state is a magnetic field sensitive state.

In an example embodiment, the first quantum state is a qubit state in a qubit sub-space of the quantum object and the second quantum state is shelving sate in a shelving sub-space of the quantum object.

In an example embodiment, the method further includes, after the amplitude of the manipulation signal is decreased to the final amplitude, causing performance of a magnetic field sensitive operation on the quantum object.

In an example embodiment, the method further includes, after performance of the magnetic field sensitive operation on the quantum object, performing a deshelving operation on the quantum object.

In an example embodiment, performing the deshelving operation comprises causing the manipulation source to provide the manipulation with the initial amplitude and one of the initial detuning or the final detuning; controlling operation of the manipulation source to cause the detuning of the manipulation signal to evolve from the one of the initial detuning or the final detuning to a zero detuning such that the frequency characterizing the manipulation signal is equal to the transition frequency and, simultaneously, to cause the amplitude to increase from the initial amplitude to a maximum amplitude; and controlling operation of the manipulation source to cause the detuning of the manipulation signal to evolve from the zero detuning to the other of the initial detuning or the final detuning and, simultaneously, to cause the amplitude to decrease from the maximum amplitude to the final amplitude.

In an example embodiment, the initial amplitude and the final amplitude are substantially equal to zero.

According to another aspect, a system configured to perform a shelving operation is provided. In an example embodiment, the system includes a confinement apparatus configured to confine one or more quantum objects at one or more target locations; one or more manipulation sources configured to generate and provide respective manipulation signals to respective ones of the one or more target locations; and a controller configured to control operation of the confinement apparatus and the one or more manipulation sources. The controller is configured to cause a manipulation source of the one or more manipulation sources to provide a manipulation signal characterized by a frequency and an amplitude. The frequency is detuned by a detuning from a transition frequency corresponding to a transition between a first quantum state of a quantum object of the one or more quantum objects and a second quantum state of the quantum object. The detuning is an initial detuning and the amplitude is an initial amplitude. The manipulation signal is provided such that it is incident on the quantum object confined at the target location. The controller is further configured to control operation of the manipulation source to cause the detuning of the manipulation signal to evolve from the initial detuning to a zero detuning such that the frequency characterizing the manipulation signal is equal to the transition frequency and, simultaneously, to cause the amplitude to increase from the initial amplitude to a maximum amplitude; and then control operation of the manipulation source to cause the detuning of the manipulation signal to evolve from the zero detuning to a final detuning and, simultaneously, to cause the amplitude to decrease from the maximum amplitude to a final amplitude.

In an example embodiment, the manipulation source is one of a laser or an integrated circuit configured to generate a microwave signal.

In an example embodiment, the initial detuning and the final detuning have opposite signs.

In an example embodiment, the initial detuning and the final detuning are equal in magnitude and have opposite signs.

In an example embodiment, the frequency is a microwave frequency.

In an example embodiment, a time period over which the detuning is evolved from the initial detuning to the zero detuning and the amplitude is increased from the initial amplitude to the maximum amplitude is longer than an inverse of a Rabi frequency of the transition.

In an example embodiment, the detuning is evolved from the initial detuning to the zero detuning and the amplitude is increased from the initial amplitude to the maximum amplitude adiabatically.

In an example embodiment, a time period over which the detuning is evolved from the zero detuning to the final detuning and the amplitude is decreased from the maximum amplitude to the final amplitude is longer than an inverse of a Rabi frequency of the transition.

In an example embodiment, the detuning is evolved from the zero detuning to the final detuning and the amplitude is decreased from the maximum amplitude to the final amplitude adiabatically.

In an example embodiment, a time period over which the detuning is evolved from the initial detuning to the zero detuning and then to the final detuning and the amplitude is increased from the initial amplitude to the maximum amplitude and then decreased from the maximum amplitude to the final amplitude is longer than an inverse of a Rabi frequency of the transition.

In an example embodiment, one of the first quantum state or the second quantum state is a magnetic field insensitive state and the other of the first quantum state or the second quantum state is a magnetic field sensitive state.

In an example embodiment, the first quantum state is a qubit state in a qubit sub-space of the quantum object and the second quantum state is shelving sate in a shelving sub-space of the quantum object.

In an example embodiment, the controller is further configured to, after the amplitude of the manipulation signal is decreased to the final amplitude, cause performance of a magnetic field sensitive operation on the quantum object.

In an example embodiment, the controller is further configured to, after performance of the magnetic field sensitive operation on the quantum object, perform a deshelving operation on the quantum object.

In an example embodiment, performing the deshelving operation comprises causing the manipulation source to provide the manipulation with the initial amplitude and one of the initial detuning or the final detuning; controlling operation of the manipulation source to cause the detuning of the manipulation signal to evolve from the one of the initial detuning or the final detuning to a zero detuning such that the frequency characterizing the manipulation signal is equal to the transition frequency and, simultaneously, to cause the amplitude to increase from the initial amplitude to a maximum amplitude; and controlling operation of the manipulation source to cause the detuning of the manipulation signal to evolve from the zero detuning to the other of the initial detuning or the final detuning and, simultaneously, to cause the amplitude to decrease from the maximum amplitude to the final amplitude.

In an example embodiment, the initial amplitude and the final amplitude are substantially equal to zero.

According to another aspect, a controller is provided. In an example embodiment, the controller includes at least one processing device and at least one non-transitory memory storing computer-executable instructions. The memory and computer-executable instructions are configured to, when executed by the at least one processing device, to cause the controller to perform at least causing a manipulation source to provide a manipulation signal characterized by a frequency and an amplitude. The frequency is detuned by a detuning from a transition frequency corresponding to a transition between a first quantum state of a quantum object and a second quantum state of the quantum object. The detuning is an initial detuning and the amplitude is an initial amplitude. The manipulation signal is caused to be incident on the quantum object. The memory and computer-executable instructions are further configured to, when executed by the at least one processing device, to cause the controller to perform at least controlling operation of the manipulation source to cause the detuning of the manipulation signal to evolve from the initial detuning to a zero detuning such that the frequency characterizing the manipulation signal is equal to the transition frequency and, simultaneously, to cause the amplitude to increase from the initial amplitude to a maximum amplitude. The memory and computer-executable instructions are further configured to, when executed by the at least one processing device, to cause the controller to perform at least controlling operation of the manipulation source to cause the detuning of the manipulation signal to evolve from the zero detuning to a final detuning and, simultaneously, to cause the amplitude to decrease from the maximum amplitude to a final amplitude.

According to another aspect, a computer program product is provided. In an example embodiment, the computer program product includes at least one non-transitory memory storing computer-executable instructions. The computer-executable instructions are configured to, when executed by a processing device of a controller configured to control operation of a confinement apparatus and one or more manipulation sources, cause the controller to perform causing a manipulation source to provide a manipulation signal characterized by a frequency and an amplitude. The frequency is detuned by a detuning from a transition frequency corresponding to a transition between a first quantum state of a quantum object and a second quantum state of the quantum object. The detuning is an initial detuning and the amplitude is an initial amplitude. The manipulation signal is caused to be incident on the quantum object. The computer-executable instructions are further configured to, when executed by the processing device of the controller, cause the controller to perform controlling operation of the manipulation source to cause the detuning of the manipulation signal to evolve from the initial detuning to a zero detuning such that the frequency characterizing the manipulation signal is equal to the transition frequency and, simultaneously, to cause the amplitude to increase from the initial amplitude to a maximum amplitude. The computer-executable instructions are further configured to, when executed by the processing device of the controller, cause the controller to perform controlling operation of the manipulation source to cause the detuning of the manipulation signal to evolve from the zero detuning to a final detuning and, simultaneously, to cause the amplitude to decrease from the maximum amplitude to a final amplitude.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 provides block diagram of an example quantum computing system, in accordance with an example embodiment.

FIG. 2 provides a partial energy space diagram of an example quantum object, in accordance with an example embodiment.

FIG. 3 provides a plot illustrating the time evolution of the amplitude and detuning of a manipulation signal used to perform a shelving or deshelving operation, in accordance with an example embodiment.

FIG. 4 provides a schematic diagram of an example controller of a quantum computer comprising a confinement apparatus configured for confining quantum objects therein, in accordance with an example embodiment.

FIG. 5 provides a flowchart illustrating various processes and/or procedures performed by a controller to cause an atomic system and/or quantum computer to perform a shelving operation, in accordance with an example embodiment.

FIG. 6 provides a schematic diagram of an example computing entity of a quantum computer system that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally” and “approximately” refer to within applicable engineering and/or manufacturing tolerances and/or within user measurement capabilities, unless otherwise indicated. Like numbers refer to like elements throughout.

In various scenarios, quantum objects are confined by a confinement apparatus. In various embodiments, the quantum objects are ions, ionic molecules, or multipolar molecules, and the confinement apparatus is an ion trap, such as a surface ion trap, Paul ion trap, and/or the like. In various embodiments, the quantum objects are neutral atoms or molecules, quantum dots, and/or the like and the confinement apparatus is an optical trap, magnetic trap, and/or the like.

In various embodiments, the internal structure of the quantum objects confined by the confinement apparatus define respective energy spaces. For example, the energy space of a quantum object may be defined, at least in part by hyperfine splitting in the case of a quantum object being an ion with a non-zero nuclear spin. A first sub-space and a second sub-space may be defined within the energy space of the quantum object. For example, the first sub-space may be defined to include a pair of states with an energy splitting therebetween that is insensitive to magnetic fields (e.g., clock states), which are referred to herein as magnetic field insensitive states. The second sub-space may be defined to include a pair of states with an energy splitting therebetween that is sensitive to magnetic fields, which are referred to herein as magnetic field sensitive states. For example, in some embodiments, the quantum objects may be moved between the magnetic field insensitive states of the first sub-space and the magnetic field sensitive states of the second sub-space for performance of various operations of the system.

In an example embodiment where the quantum objects are used as qubits of a quantum computer, the first sub-space may be a qubit sub-space with the states therein being the qubit states of the qubit. The second sub-space may be a shelving sub-space. For example, the quantum objects may be shelved to the second sub-space that includes magnetic field sensitive states for performance of a quantum logic gate (e.g., single-qubit gate, two-qubit gate, and/or the like) or other interaction that is caused or mediated by a magnetic field or magnetic field gradient. In various embodiments, the quantum objects may be shelved into the second sub-space for performance of a quantum state detection and/or measurement operation.

For example, in an example embodiment, one or more quantum objects may be shelved (or deshelved) in accordance with an example embodiment for performance of a geometric phase gate, as disclosed by U.S. Application No. 63/487,076, filed Feb. 27, 2023, the content of which is incorporated herein by reference in its entirety. In various embodiments, the shelving process includes application of a manipulation signal to the one or more quantum objects. In various embodiments, the manipulation signal is a laser beam or laser pulses or a microwave signal. For example, one or more manipulation sources such as one or more lasers or a microwave sources (e.g., similar to the dressing field source disclosed in U.S. Application No. 63/581,017, filed Sep. 7, 2023, the content of which is incorporated herein by reference in its entirety) may be used to generate one or more manipulation signals for use in performing a shelving (or deshelving) operation.

In various embodiments, the manipulation signal is a dynamic manipulation signal. For example, the amplitude and the frequency that characterizes the manipulation signal are adjusted, modified, and/or caused to evolve over the performance of the shelving (or deshelving) operation. In various embodiments, the adjustments, modifications, and/or evolutions of the amplitude and/or frequency that characterizes the manipulation signal are adiabatic. In other words, the adjustments, modifications, and/or evolutions of the amplitude and/or frequency that characterizes the manipulation signal are slow enough (with respect to time) that quantum object is able to adjust to the adjustments, modifications, and/or evolutions without transition to other eigenstates. For example, some of the energy states of the energy space are coupled to respective other energy states of the energy space by the manipulation signal without the energy states themselves being modified.

Conventional shelving/deshelving techniques include applying a laser beam to a quantum object to shelve or deshelve the quantum object using a Rabi flop. However, driving the shelving transitions using a Rabi flop is complicated. For example, for a first sub-space including qubit states F=1, m=0 and F=2, m=0, it may be desired to shelve to the second sub-space including states F=2, m=1 and F=1, m=1. For example, the F=1, m=0 qubit state may be shelved to the F=2, m=1 state and the F=2, m=0 qubit state may be shelved to the F=1, m =1 state. However, the frequency difference between the F=1, m=0 qubit state and the F=2, m=1 state is sufficiently similar to the frequency difference between the F=2, m=0 qubit state and the F=1, m=1 state that both of the transitions are simultaneously driven with a single laser or microwave tone. The length of time for which the single laser or microwave tone is applied to cause a near 100% population inversion via the Rabi flop is the inverse of the Rabi frequency of the transition. However, the Rabi frequencies of the two transitions are different by a factor of an irrational number. Therefore, the shelving transitions cannot be performed with near 100% probability for both pairs of states. Thus, the probability of performing a complete shelving of both qubit states is not high enough for the performance of high-fidelity quantum logic gate, for example. As such, technical problems exist regarding the shelving and deshelving of quantum objects.

Various embodiments provide technical solutions to these technical problems. For example, various embodiments use an adiabatic rapid passage (ARP) to perform a shelving or deshelving operation. An ARP-based shelving operation allows for a complete (e.g., probability nearing 100%) shelving of both states of the first sub-space. To perform the ARP-based shelving operation, a manipulation signal (e.g., a microwave or laser pulse) is slowly turned on from zero-amplitude with the frequency characterizing the manipulation signal being detuned from the shelving transition(s) by an initial (non-zero) detuning. The amplitude of the manipulation signal is increased from zero amplitude to a maximum amplitude. As the amplitude is increased, the frequency characterizing the manipulation signal is evolved such that the frequency characterizing the manipulation signal is resonant with the shelving transition(s) when the amplitude of the manipulation signal is at the maximum amplitude. The amplitude of the manipulation signal is then decreased from the maximum amplitude to zero amplitude while the frequency characterizing the manipulation signal continues to evolve. When the amplitude of the manipulation signal reaches zero amplitude, the frequency characterizing the manipulation signal is at a final detuning from the shelving transition(s). In an example embodiment, the initial detuning and the final detuning have substantially the same magnitude and opposite signs.

In various embodiments, the process is performed slowly compared to the Rabi frequencies of the shelving transitions and the frequency splitting of the Zeeman states of the first and second sub-spaces. For example, the time required to increase the amplitude of the manipulation signal from zero amplitude to the maximum amplitude may be longer than the inverses of the Rabi frequencies of the shelving transitions. Similarly, the time required to decrease the amplitude of the manipulation signal from the maximum amplitude to zero amplitude may be longer than the inverses of the Rabi frequencies of the shelving transitions.

The slow amplitude and frequency changes of the manipulation signal enable the transition to be driven with a high likelihood of success (e.g., a probability that is independent of the coupling strength of the transition) while (coherently) maintaining the quantum information stored by the qubits. Thus, embodiments provide technical improvements and technical advantages to the fields of quantum object shelving (and/or deshelving) and atomic systems and/or quantum computers that use shelving (and/or deshelving) operations.

### Exemplary Quantum Computer Comprising a Confinement Apparatus

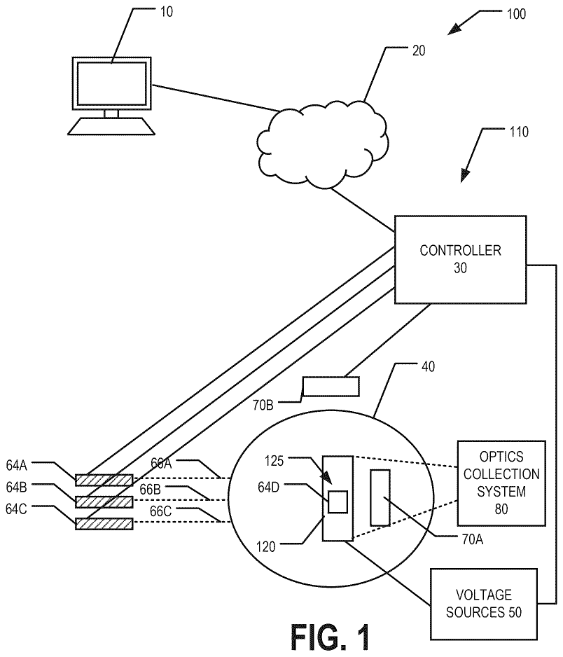

Various embodiments provide atomic systems and/or quantum computers (e.g., quantum charge-coupled device (QCCD)-based quantum computers) that are configured for performing shelving (and/or deshelving) operations in accordance with various embodiments. FIG. 1 provides a schematic diagram of an example quantum computer system 100 configured to perform shelving (and/or deshelving) operations in accordance with various embodiments.

In the illustrated embodiment, the quantum computer system 100 includes a confinement apparatus 120 (e.g., an ion trap) configured to confine one or more quantum objects. In various embodiments, the quantum computer system 100 comprises a computing entity 10 and a quantum computer 110. In various embodiments, the quantum computer 110 comprises a controller 30, a cryostat and/or vacuum chamber 40 enclosing a confinement apparatus 120, one or more manipulation sources 64 (e.g., 64A, 64B, 64C, 64D), one or more voltage sources 50, one or more magnetic field generators 70 (e.g., 70A, 70B), an optics collection system 80, and/or the like. In various embodiments, the controller 30 is configured to control the operation of (e.g., control one or more drivers configured to cause operation of) the manipulation sources 64, voltage sources 50, magnetic field generators 70, a vacuum system and/or cryogenic cooling system (not shown), and/or the like. In various embodiments, the controller 30 is configured to receive signals (e.g., electrical signals) generated and provided by one or more photodetectors of the optics collection system 80.

In an example embodiment, the one or more manipulation sources 64 may comprise one or more lasers (e.g., optical lasers, microwave sources and/or masers, and/or the like) or another manipulation source. In the illustrated embodiment, manipulation sources 64A, 64B, 64C are lasers located outside of the cryogenic and/or vacuum chamber and manipulation source 64D is either a laser that is integrated with the confinement apparatus 120 or a microwave source integrated with the confinement apparatus 120. For example, the integrated microwave source may be similar to the dressing field source disclosed in U.S. Application No. 63/581,017, filed Sep. 7, 2023, the content of which is incorporated herein by reference in its entirety.

In various embodiments, the one or more manipulation sources 64 are configured to manipulate and/or cause a controlled quantum state evolution of one or more quantum objects confined by the confinement apparatus 120. For example, a manipulation signal generated by one of the manipulation signals may be incident on and/or interact with one or more quantum objects confined at the target location 125 of the confinement apparatus 120 to cause a shelving (or deshelving) operation to be performed on the one or more quantum objects.

In various embodiments, the confinement apparatus 120 is an ion trap, such as a surface ion trap, Paul ion trap, and/or the like. In various embodiments, the quantum objects are ions, atoms, molecules, and/or the like. For example, the quantum objects define an energy space. A first sub-space is defined within the energy space. In various embodiments, the first sub-space is a qubit sub-space including two qubit states. In various embodiments, the states of the first sub-space are magnetic field insensitive states (e.g., clock states). A second sub-space is defined with the energy space. In various embodiments, the second sub-space includes magnetic field sensitive states. For example, quantum objects may be shelved from the first sub-space to the second sub-space and/or deshelved from the second sub-space to the first sub-space, in various embodiments.

In an example embodiment, the one or more manipulation sources 64A, 64B, 64C each provide a manipulation signal (e.g., laser beam, microwave signals, and/or the like) to one or more regions and/or target locations 125 of the confinement apparatus 120 via corresponding beam paths 66 (e.g., 66A, 66B, 66C). In various embodiments, at least one beam path 66 comprises a modulator configured to modulate the manipulation signal being provided to the confinement apparatus 120 via the beam path 66. In various embodiments, the manipulation sources 64, active components of the beam paths (e.g., modulators, etc.), and/or other components of the quantum computer 110 are controlled by the controller 30.

In various embodiments, the quantum computer 110 comprises one or more voltage sources 50. For example, the voltage sources may be arbitrary wave generators (AWG), digital analog converters (DACs), and/or other voltage signal generators. For example, the voltage sources 50 may comprise a plurality of control voltage drivers and/or voltage sources and/or at least one RF driver and/or voltage source. The voltage sources 50 may be electrically coupled to the corresponding potential generating elements (e.g., control electrodes and/or RF electrodes) of the confinement apparatus 120, in an example embodiment.

In various embodiments, the quantum computer 110 comprises one or more magnetic field generators 70 (e.g., 70A, 70B). For example, the magnetic field generator may be an internal magnetic field generator 70A disposed within the cryogenic and/or vacuum chamber 40 and/or an external magnetic field generator 70B disposed outside of the cryogenic and/or vacuum chamber 40. In various embodiments, the magnetic field generators 70 comprise permanent magnets, Helmholtz coils, electrical magnets, and/or the like. In various embodiments, the magnetic field generators 70 are configured to generate a magnetic field at one or more regions and/or target locations 125 of the confinement apparatus 120 that has a particular magnitude and a particular magnetic field direction in the one or more regions and/or target locations 125 of the confinement apparatus 120.

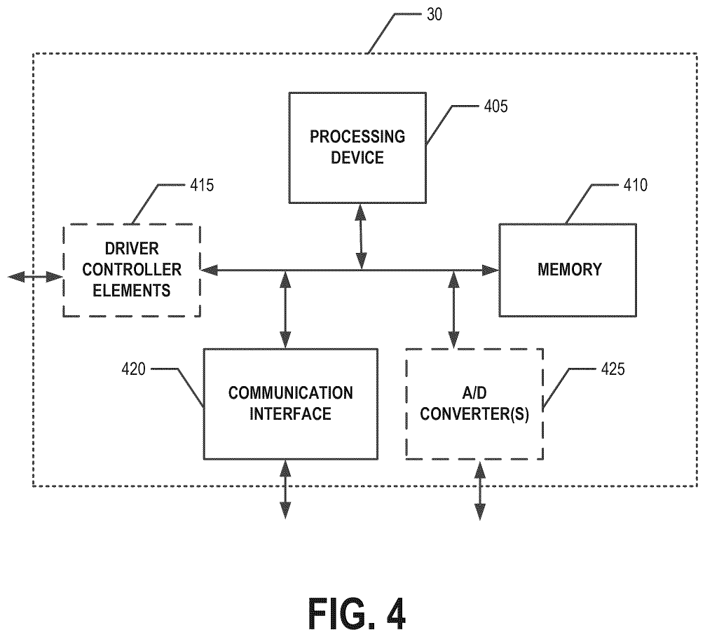

In various embodiments, the quantum computer 110 comprises an optics collection system 80 configured to collect and/or detect photons (e.g., stimulated emission) generated by qubits (e.g., during reading procedures). The optics collection system 80 may comprise one or more optical elements (e.g., lenses, mirrors, waveguides, fiber optics cables, and/or the like) and one or more photodetectors. In various embodiments, the photodetectors may be photodiodes, photomultipliers, charge-coupled device (CCD) sensors, complementary metal oxide semiconductor (CMOS) sensors, Micro-Electro-Mechanical Systems (MEMS) sensors, and/or other photodetectors that are sensitive to light at an expected fluorescence wavelength of the qubits (e.g., quantum objects) of the quantum computer 110. In various embodiments, the detectors may be in electronic communication with the controller 30 via one or more A/D converters 425 (see FIG. 4) and/or the like.

In various embodiments, a computing entity 10 is configured to allow a user to provide input to the quantum computer 110 (e.g., via a user interface of the computing entity 10) and receive, view, and/or the like output from the quantum computer 110. The computing entity 10 may be in communication with the controller 30 of the quantum computer 110 via one or more wired or wireless networks 20 and/or via direct wired and/or wireless communications. In an example embodiment, the computing entity 10 may translate, configure, format, and/or the like information/data, quantum computing algorithms (e.g., quantum circuits), and/or the like into a computing language, executable instructions, command sets, and/or the like that the controller 30 can understand, execute, and/or implement.

In various embodiments, the controller 30 is configured to control operation of the voltage sources 50, magnetic field generators 70, cryogenic system and/or vacuum system controlling the temperature and pressure within the cryogenic and/or vacuum chamber 40, manipulation sources 64, and/or other systems controlling various environmental conditions (e.g., temperature, pressure, and/or the like) within the cryogenic and/or vacuum chamber 40, configured to manipulate and/or cause a controlled evolution of quantum states of one or more quantum objects within the confinement apparatus, and/or read and/or detect a quantum (e.g., qubit) state of one or more quantum objects confined by the confinement apparatus. For example, the controller 30 may cause a controlled evolution of quantum states of one or more quantum objects within the confinement apparatus to execute a quantum circuit and/or algorithm. For example, the controller 30 may perform one or more shelving and/or deshelving operations on one or more quantum objects confined by the confinement apparatus at one or more points during the execution of a quantum circuit. In various embodiments, the quantum objects confined by the confinement apparatus are used as qubits of the quantum computer 110.

### Exemplary Shelving/Deshelving Operation

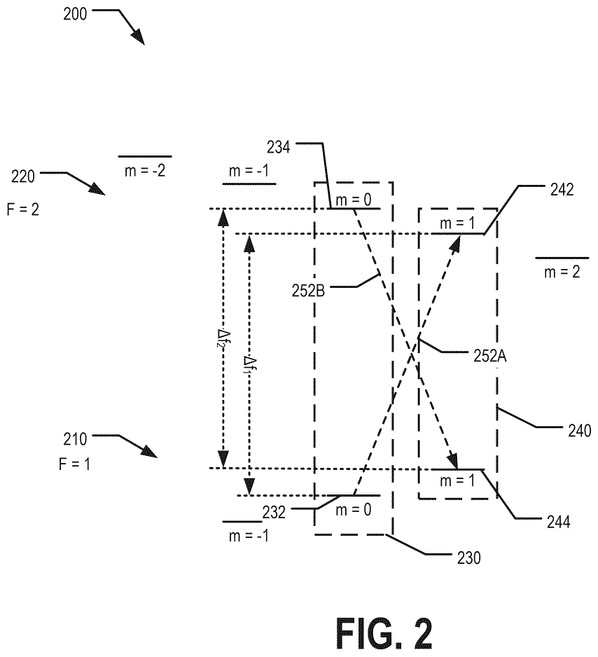

FIG. 2 illustrates a portion of the energy space 200 of an example quantum object. The illustrated portion of the energy space 200 includes a first manifold 210, which in the illustrated example is the F=1 manifold of a quantum object that is an ion with a nuclear spin of ½. The illustrated portion of the energy space 200 also includes a second manifold 220, which in the illustrated example is the F=2 manifold of the quantum object. For example, in the illustrated portion of the energy space 200, the first manifold 210 consists of the F=1, m=−1; F =1, m=0; and F=1, m=1 states and the second manifold 220 consists of the F=2, m=−2; F =2, m=−1; F=2, m=0; F=2, m=1; and F=2, m=2 states.

A first sub-space 230 and a second sub-space 240 are defined within the energy space 200. In an example embodiment, the first sub-space 230 is a qubit space including qubit states. For example, the first and second state of the first sub-space 230 are a first qubit state 232 and a second qubit state 234, in an example embodiment. In various embodiments, the states of the first sub-space 230 are magnetic field insensitive states (e.g., clock states). For example, the energy and/or frequencies of the states of the first sub-space 230 are, at least to first order, not dependent on the external magnetic field experienced by the quantum object.

The second sub-space 240 includes a first shelving state 242 and second shelving state 244. In various embodiments, the states of the second sub-space are sensitive to the magnetic fields. For example, the energy and/or frequency of the first shelving state 242 and the second shelving state 244 are dependent on the external magnetic field experienced by the quantum object, in an example embodiment.

In various embodiments, the shelving operation includes performing a shelving transition. For example, a shelving operation includes transitioning a quantum object from a first quantum state to a second quantum state. In various embodiments, the first quantum state and the second quantum state are in different sub-spaces of the energy space of the quantum object.

As used herein, a shelving transition transitions and/or evolves the quantum state of a quantum object from a first quantum state in a first sub-space 230 to a second quantum state in a second sub-space 240. For example, a shelving transition includes causing a quantum object in a first qubit state 232 in a first sub-space 230 to transition to a first shelving state 242 in a second sub-space 240 via a first transition 252A, in an example embodiment. In another example, a shelving transition includes causing a quantum object in a second qubit state 234 in a first sub-space 230 to transition to a second shelving state 244 in a second sub-space 240 via a second transition 252B, in an example embodiment. For example, the manipulation signal couples a particular state in the first sub-space to a particular state in the second sub-space so as to cause a population inversion therebetween to perform a shelving operation.

In various embodiments, a deshelving operation includes performing a deshelving transition. As used herein, a deshelving transition transitions and/or evolves the quantum state of a quantum object from the second quantum state in the second sub-space 240 to the first quantum state in the first sub-space 230. For example, a deshelving transition includes causing a quantum object in a first shelving state 242 in a second sub-space 240 to transition to a first qubit state 232 in a first sub-space 230 via a first transition 252A, in an example embodiment. In another example, a deshelving transition includes causing a quantum object in a second shelving state 244 in a second sub-space 240 to transition to a second qubit state 234 in a first sub-space 230 via a second transition 252B, in an example embodiment.

In various embodiments, shelving the quantum object includes coupling the first qubit state 232 and the first shelving state 242 to cause performance of a first transition 252A. For example, the first transition 252A corresponds to transitioning the quantum object from the first qubit state 232 to the first shelving state 242. The first transition 252A is characterized by a first frequency Δf₁, which is the frequency difference between the first shelving state 242 and the first qubit state 232.

In various embodiments, shelving the quantum object includes coupling the second qubit state 234 and the second shelving state 244 to cause performance of a second transition 252B. For example, the second transition 252B corresponds to transitioning the quantum object from the second qubit state 234 to the second shelving state 244. The second transition 252B is characterized by a second frequency Δf₂, which is the frequency difference between the second qubit state 234 and the second shelving state 244.

In various embodiments, the first frequency Δf₁ and the second frequency Δf₂ are sufficiently similar that the first transition 252A and the second transition 252B may be driven and/or caused using a single tone, referred to herein as a transition frequency. For example, in an example embodiment, the difference between the first frequency Δf₁ and the second frequency Δf₂ may be less than the maximum amplitude the manipulation signal, in an example embodiment. Thus, the first transition 252A and the second transition 252B may be driven and/or caused by a single manipulation signal characterized, at least in part by the transition frequency. In the example embodiment illustrated in FIG. 2, the first frequency difference Δf₁ and the second frequency difference Δf₂ are approximately equal to one another such that both the first transition 252A and the second transition 252B are simultaneously driven by the sample manipulation signal.

In various embodiments, a deshelving operation is the opposite of a shelving operation. For example, a quantum object may be shelved from the first sub-space 230 to the second sub-space 240 and deshelved from the second sub-space 240 to the first sub-space 230. For example, performing a deshelving operation includes performing the first and second transitions 252A, 252B in the opposite direction (e.g., flipping the arrows illustrating the first and second transitions 252A, 252B).

In various embodiments, a shelving (or deshelving) operation is performed by causing a manipulation signal to be incident on the quantum object. In various embodiments, the manipulation signal is a laser or microwave pulse. In various embodiments, the manipulation signal is characterized by an amplitude and a frequency. Over the course of the shelving (or deshelving operation), the amplitude of the manipulation signal increases from zero amplitude to a maximum amplitude and then decreases back to zero amplitude. The frequency that characterizes the manipulation signal fₘ is equal to a transition frequency fₜ plus a detuning δ (e.g., fₘ=fₜ+δ). While the amplitude of the manipulation signal is increasing from zero amplitude to the maximum amplitude, the detuning δ evolves from an initial detuning δ₀ to a zero detuning δ=0. While the amplitude of the manipulation signal is decreasing from the maximum amplitude to zero amplitude, the detuning δ evolves from a zero detuning δ=0 to a final detuning δ_{f}. In various embodiments, the initial detuning δ₀ and the final detuning δ_{f} have different signs. For example, the initial detuning δ₀ is negative and the final detuning δ_{f} is positive, or vice versa. In various embodiments, the initial detuning δ₀ and the final detuning δ_{f} have the same magnitude and different signs (e.g., δ₀=−δ_{f}).

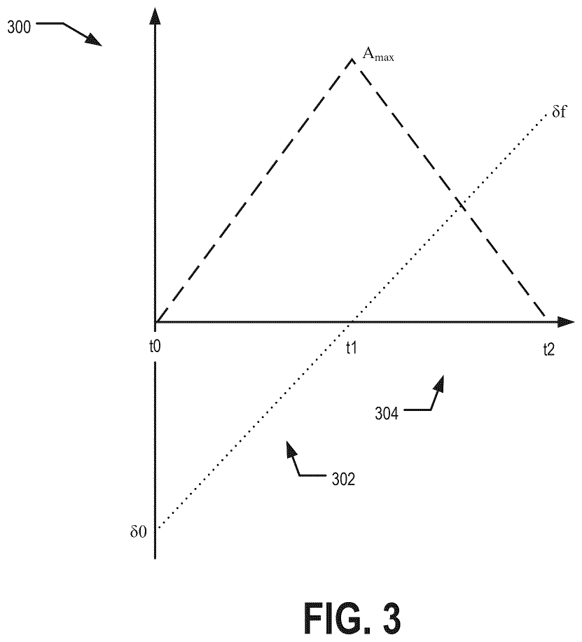

FIG. 3 provides a plot 300 illustrating the time evolution of the amplitude and frequency of a manipulation signal used to perform a shelving (or deshelving) operation, according to an example embodiment. The shelving (or deshelving) operation begins at an initial time t₀. At the initial time, the amplitude of the manipulation signal is a zero amplitude (e.g., the amplitude is equal to zero) and the frequency characterizing the manipulation signal is the sum of the transition frequency of the shelving (or deshelving) operation and the initial detuning δ₀. In the illustrated embodiment, the initial detuning δ₀ is negative and the final detuning δ_{f} is positive. In another example embodiment, the final detuning δ_{f} is negative and the initial detuning δ₀ is positive.

At a first time t₁ (t₁>t₀), the amplitude of the manipulation signal is a maximum amplitude and the frequency characterizing the manipulation signal is the transition frequency (e.g., the detuning is a zero detuning such that δ=0). Between the initial time t₀ and the first time t₁, the amplitude of the manipulation signal increases from the initial zero amplitude to the maximum amplitude as shown by the dashed line of plot 300. Between the initial time t₀ and the first time t₁, the detuning evolves from the initial detuning δ₀ to a zero detuning (e.g., δ=0), as shown by the dotted line of plot 300.

At a second time t₂ (t₂>t₁), the amplitude of the manipulation signal is a zero amplitude and the frequency characterizing the manipulation signal is sum of the transition frequency of the shelving (or deshelving) operation and the final detuning δ_{f}. Between the first time t₁ and the second time t₂, the amplitude of the manipulation signal decreases from the maximum amplitude to a zero amplitude and the detuning evolves from the zero detuning to the final detuning δ_{f}.

In an example embodiment, the evolution of the detuning δ is smooth and/or continuous from the initial detuning δ₀ to the final detuning δ_{f}. In an example embodiment, the evolution of the detuning δ is linear with respect to time. In various embodiments, the evolution of the detuning δ has another functional form with respect to time such as a portion (e.g., quarter of a period) of a sine curve, portion (e.g., half a period) of a cosine curve, exponential curve, and/or the like.

In various embodiments, the increase in the amplitude of the manipulation signal between the initial time t₀ and the first time t₁ is smooth and continuous and the decrease in the amplitude of the manipulation signal between the first time t₁ and the second time t₂ is smooth and continuous. In various embodiments, the increase/decrease in the amplitude is linear and/or of another functional form with respect to time (over the respective time period).

In various embodiments, the change, increase/decrease, and/or evolution of the amplitude and/or the detuning occurs slowly with respect to one or more time scales of the quantum object and/or energy space 200. For example, in various embodiments, the change, increase/decrease, and/or evolution of the amplitude and/or the detuning is performed slowly compared to the Rabi frequencies of the first and second transitions 252A, 252B and the frequency splitting of the Zeeman states (e.g., the frequency splitting between states of the same manifold).

For example, the time required to increase the amplitude of the manipulation signal from zero amplitude to the maximum amplitude and to evolve the detuning from the initial detuning to zero detuning may be longer than the inverses of the Rabi frequencies of the first and second transitions 252A, 252B. For example, in various embodiments, the first time period 302 between the initial time t₀ and the first time t₁ is longer than the inverse of the Rabi frequencies of both the first transition 252A and the second transition 252B (e.g., t₁−t₀>1/Ω, where Ω is the Rabi frequency of a shelving transition being performed). Similarly, the time required to decrease the amplitude of the manipulation signal from the maximum amplitude to zero amplitude and to evolve the detuning from the zero detuning to the final detuning may be longer than the inverses of the Rabi frequencies of the first and second transitions 252A, 252B. For example, in various embodiments, the second time period 304 between the first time t₁ and the second time t₂ is longer than the inverse of the Rabi frequencies of both the first transition 252A and the second transition 252B (e.g., t₂−t₁>1/Ω, where Ω is the Rabi frequency of a shelving transition being performed).

In an example embodiment, the time period between when the manipulation signal is initially provided to the target location and when the manipulation signal is no longer provided to the target location (e.g., the time period between the initial time t₀ and the second time t₂) is longer than the inverse of the Rabi frequencies of both the first transition 252A and the second transition 252B (e.g., t₂−t₀>1/Ω, where Ω is the Rabi frequency of a shelving transition being performed).

The slow changes in the amplitude and frequency characterizing the manipulation signal enables the shelving (or deshelving) transition(s) to be driven with a high likelihood of success (e.g., a probability that is independent of the coupling strength of the transition) while (coherently) maintaining the quantum information stored by the quantum object.

### Example Controller

In various embodiments, a confinement apparatus 120 is incorporated into a quantum computer 110 or other atomic system. In various embodiments, a quantum computer 110 or other atomic system further comprises a controller 30 configured to control various elements of the quantum computer 110 or other atomic system. For example, the controller 30 may be configured to control the voltage sources 50, a cryogenic system and/or vacuum system controlling the temperature and pressure within the cryogenic and/or vacuum chamber 40, manipulation sources 64 (e.g., 64A, 64B, 64C, 64D), magnetic field generators 70, active components of beam paths 66, and/or other systems controlling the environmental conditions (e.g., temperature, humidity, pressure, and/or the like) within the cryogenic and/or vacuum chamber 40, configured to manipulate and/or cause a controlled evolution of quantum states of one or more quantum objects confined by the confinement apparatus 120, and/or read and/or detect a quantum state of one or more quantum objects within the confinement apparatus 120. For example, the controller 30 may be configured to control operation of the confinement apparatus 120 (e.g., via controlling one or more voltage sources 50 configured to provide voltage signals to various potential generating elements/electrodes of the confinement apparatus, in an example embodiment).

As shown in FIG. 4, in various embodiments, the controller 30 may comprise various controller elements including processing device 405, memory 410, driver controller elements 415, a communication interface 420, analog-digital converter elements 425, and/or the like. For example, the processing device 405 may comprise processing elements, programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like, and/or controllers. The term circuitry may refer to an entirely hardware embodiment or a combination of hardware and computer program products. In an example embodiment, the processing device 405 of the controller 30 comprises a clock and/or is in communication with a clock.

For example, the memory 410 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 410 may store qubit records corresponding the qubits of quantum computer (e.g., in a qubit record data store, qubit record database, qubit record table, and/or the like), a calibration table, an executable queue, computer program code (e.g., in a one or more computer languages, specialized controller language(s), and/or the like), and/or the like. In an example embodiment, execution of at least a portion of the computer program code stored in the memory 410 (e.g., by a processing device 405) causes the controller 30 to perform one or more steps, operations, processes, procedures and/or the like described herein for controlling one or more components of the quantum computer 110 or other atomic system (e.g., voltages sources 50, manipulation sources 64, magnetic field generators 70, and/or the like) to cause a controlled evolution of quantum states of one or more quantum objects, detect and/or read the quantum state of one or more quantum objects, and/or the like.

In various embodiments, the driver controller elements 415 may include one or more drivers and/or controller elements each configured to control one or more drivers. In various embodiments, the driver controller elements 415 may comprise drivers and/or driver controllers. For example, the driver controllers may be configured to cause one or more corresponding drivers to be operated in accordance with executable instructions, commands, and/or the like scheduled and executed by the controller 30 (e.g., by the processing device 405). In various embodiments, the driver controller elements 415 may enable the controller 30 to operate a manipulation source 64. In various embodiments, the drivers may be laser drivers; vacuum component drivers; drivers for controlling the flow of current and/or voltage applied to longitudinal, RF, and/or other electrodes used for maintaining and/or controlling the confinement potential of the confinement apparatus (and/or other driver for providing driver action sequences and/or control signals to potential generating elements of the confinement apparatus); cryogenic and/or vacuum system component drivers; and/or the like. For example, the drivers may control and/or comprise control and/or RF voltage drivers and/or voltage sources that provide voltages and/or electrical signals to the potential generators (e.g., control electrodes and/or RF electrodes). In various embodiments, the controller 30 comprises means for communicating and/or receiving signals from one or more detectors such as optical receiver components (e.g., cameras, MEMs cameras, CCD cameras, photodiodes, photomultiplier tubes, and/or the like). For example, the controller 30 may comprise one or more analog-digital converter elements 425 configured to receive signals from one or more detectors, optical receiver components, calibration sensors, photodetectors of an optics collection system 80, and/or the like.

In various embodiments, the controller 30 may comprise a communication interface 420 for interfacing and/or communicating with a computing entity 10. For example, the controller 30 may comprise a communication interface 420 for receiving executable instructions, command sets, and/or the like from the computing entity 10 and providing output received from the quantum computer 110 (e.g., from an optics collection system 80 comprising one or more photodetectors) and/or the result of a processing the output to the computing entity 10. In various embodiments, the computing entity 10 and the controller 30 may communicate via a direct wired and/or wireless connection and/or one or more wired and/or wireless networks 20.

### Example Method of Performing a Shelving (or Deshelving) Operation

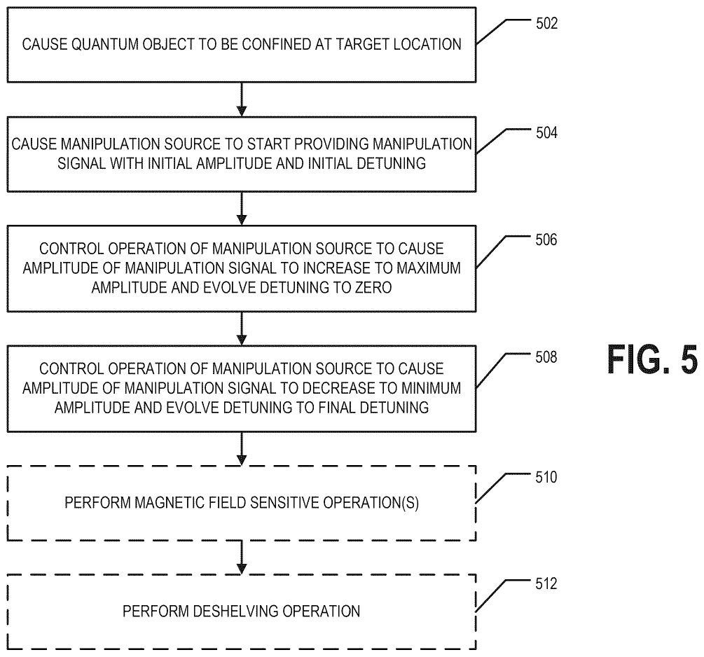

FIG. 5 provides a flowchart illustrating various processes, procedures, and/or the like performed by a controller 30 of a quantum computer 110 and/or atomic system for performing a shelving operation, in accordance with various embodiments. In various embodiments, the shelving operation is performed as part of and/or in preparation of performing a magnetic field sensitive operation (e.g., a quantum logic gate mediated by a magnetic field gradient), a quantum state reading operation, and/or the like.

Starting at step 502, the controller 30 causes one or more quantum objects on which the shelving operation is to be performed to be located and/or confined at respective target locations 125. For example, one or more quantum objects on which the shelving operation is to be performed may be disposed at one or more target locations 125. When it is determined (e.g., based on a quantum object or qubit record stored in memory 410 of the controller 30) that a quantum object on which a shelving operation is to be performed is not located at a respective target location 125, the controller 30 causes the confinement apparatus 120 to transport the quantum object to the target location 125. For example, the controller 30 controls operation of the voltage sources 50 to cause transportation of the quantum object to the target location 125.

At step 504, the controller 30 controls operation of one or more manipulation sources 64 to cause the manipulation signal to be provided to the target location 125 with the manipulation signal characterized by an initial amplitude and a frequency that is equal to the sum of transition frequency and the initial detuning. In various embodiments, the initial amplitude is an approximately zero amplitude. For example, the initial amplitude may be a lowest or minimum amplitude of the manipulation signal providable to the target location 125 by the manipulation source 64 and/or the corresponding beam path 66. For example, the controller 30 causes the manipulation signal to be “turned on” with a small amplitude (e.g., approximately zero amplitude) and characterized by a transition frequency fₜ plus an initial detuning δ₀.

In various embodiments, the controller 30 controls operation of one or more manipulation sources 64 via execution of executable instructions by the processing device 405 and/or driver controller elements 415 configured to control operation of the respective manipulation sources.

In an example embodiment, the manipulation signal is a laser pulse or beam generated by a manipulation source 64 that is a laser and is provided to the target location 125 via a beam path 66. In an example embodiment, the manipulation signal is a microwave pulse and/or signal generated by a manipulation source 64D that is an integrated circuit formed on the same substrate as the confinement apparatus 120 and/or another substrate secured with respect to the confinement apparatus (e.g., similar to the dressing field source disclosed in U.S. Application No. 63/581,017, filed Sep. 7, 2023).

At step 506, the controller 30 controls operation of the one or more manipulation sources 64 to cause the amplitude of the manipulation signal to increase from the initial (small and/or approximately zero) amplitude to a maximum amplitude. While the controller 30 causes the amplitude of the manipulation signal to increase, the controller 30 also controls operation of the one or more manipulation sources 64 to cause the detuning δ with which the frequency characterizing the manipulation signal is detuned from the transition frequency of the shelving operation. For example, the controller 30 causes the frequency characterizing the manipulation signal to evolve from an initial frequency equal to the sum of the transition frequency fₜ and the initial detuning δ₀ to the transition frequency fₜ. For example, the detuning δ is evolved from the initial detuning δ₀ to a zero detuning δ=0.

In various embodiments, the amplitude and detuning of the manipulation signal are evolved slowly compared to the Rabi frequency of the shelving transition and/or compared to the hyperfine splitting and/or frequency splitting of the Zeeman states of the energy space of the quantum object. In an example embodiment, the evolution of the detuning δ is smooth and/or continuous from the initial detuning δ₀ to the zero detuning. In an example embodiment, the evolution of the detuning δ is linear with respect to time. In various embodiments, the evolution of the detuning δ has another functional form with respect to time such as a portion (e.g., quarter of a period) of a sine curve, portion (e.g., half a period) of a cosine curve, exponential curve, and/or the like.

In various embodiments, the increase in the amplitude of the manipulation signal from the initial amplitude to the maximum amplitude is smooth and continuous. In various embodiments, the increase in the amplitude is linear and/or of another functional form with respect to time (over the respective time period).

For example, the time required to increase the amplitude of the manipulation signal from the initial amplitude (e.g., an approximately zero amplitude) to the maximum amplitude and to evolve the detuning from the initial detuning to zero detuning may be longer than the inverse of the Rabi frequency of the shelving transition. For example, in various embodiments, the time period over which the amplitude is increased form the initial amplitude to the maximum amplitude and the detuning is evolved from the initial detuning to the zero detuning is longer than the inverse of the Rabi frequencies of the shelving transition (e.g., t₁−t₀>1/Ω, where Ω is the Rabi frequency of the shelving transition being performed).

In various embodiments, the controller 30 controls operation of one or more manipulation sources 64 via execution of executable instructions by the processing device 405 and/or driver controller elements 415 configured to control operation of the respective manipulation sources.

At step 508, the controller 30 controls operation of the one or more manipulation sources 64 to cause the amplitude of the manipulation signal to decrease from the maximum amplitude to a final (approximately zero) amplitude. While the controller 30 causes the amplitude of the manipulation signal to decrease, the controller 30 also controls operation of the one or more manipulation sources 64 to cause the detuning δ with which the frequency characterizing the manipulation signal is detuned from the transition frequency of the shelving operation. For example, the controller 30 causes the frequency characterizing the manipulation signal to evolve from the transition frequency fₜ to equal to the sum of the transition frequency fₜ and the final detuning δ_{f}. For example, the detuning δ is evolved from the zero detuning δ=0 to a final detuning δ_{f}. In various embodiments, the final detuning δ_{f} has the opposite sign of the initial detuning δ₀. In an example embodiment, the final detuning δ_{f} and the initial detuning δ₀ have the same magnitude and opposite signs (e.g., δ_{f}=−δ₀).

In various embodiments, the amplitude and detuning of the manipulation signal are evolved slowly compared to the Rabi frequency of the shelving transition and/or compared to the hyperfine splitting and/or frequency splitting of the Zeeman states of the energy space of the quantum object. In an example embodiment, the evolution of the detuning δ is smooth and/or continuous from the zero detuning to the final detuning δ_{f}. In an example embodiment, the evolution of the detuning δ is linear with respect to time. In various embodiments, the evolution of the detuning δ has another functional form with respect to time such as a portion (e.g., quarter of a period) of a sine curve, portion (e.g., half a period) of a cosine curve, exponential curve, and/or the like.

In various embodiments, the decrease in the amplitude of the manipulation signal from the maximum amplitude to the final (approximately zero) amplitude is smooth and continuous. In various embodiments, the decrease in the amplitude is linear and/or of another functional form with respect to time (over the respective time period).

For example, the time required to decrease the amplitude of the manipulation signal from the maximum amplitude to the final (approximately zero) amplitude and to evolve the detuning from the zero detuning to the final detuning may be longer than the inverse of the Rabi frequency of the shelving transition. For example, in various embodiments, the time period over which the amplitude is decreased form the maximum amplitude to the final amplitude and the detuning is evolved from the zero detuning to the final detuning is longer than the inverse of the Rabi frequencies of the shelving transition (e.g., t₂−t₁>1/Ω, where Ω is the Rabi frequency of the shelving transition being performed).

In various embodiments, the controller 30 controls operation of one or more manipulation sources 64 via execution of executable instructions by the processing device 405 and/or driver controller elements 415 configured to control operation of the respective manipulation sources.

The slow amplitude and frequency changes of the manipulation signal enable the transition to be driven with a high likelihood of success (e.g., a probability that is independent of the coupling strength of the transition) while (coherently) maintaining the quantum information stored by the quantum objects which are being shelved via the shelving operation.

At step 510, the controller 30 controls various components of the atomic system and/or quantum computer to cause one or more operations to be performed while the one or more quantum objects are shelved. For example, the controller 30 may cause a magnetic field sensitive quantum logic operation (e.g., a single qubit, two-qubit, and/or multi-qubit quantum logic gate that is mediated by a magnetic field gradient) while the one or more quantum objects confined at the target location are shelved. In another example, the controller 30 may perform a quantum state reading operation to determine the quantum state (e.g., encoding the quantum information stored by the quantum object) while the quantum objects confined at the target location are shelved. Various operations may be performed while the one or more quantum objects are shelved, in various embodiments, as appropriate for the application.

At step 512, the quantum objects confined at the target location 125 are deshelved. For example, the controller 30 controls operation of the one or more manipulation sources 64 to perform a deshelving operation of one or more quantum objects confined at respective target locations 125. In various embodiments, a deshelving operation is similar to a shelving operation. For example. Performing a deshelving operation, in an example embodiment, includes performing steps 504-508. For example, the controller 30 controls operation of the one or more manipulation sources 64 to cause a manipulation signal to be provided to the target location 125 with an initial (approximately zero) amplitude and characterized by a frequency equal to the sum of the transition frequency of deshelving operation (generally the same frequency as the transition frequency of the corresponding/inverse shelving operation) and an initial detuning. The controller 30 controls operation of the one or more manipulation sources to cause the amplitude of the manipulation signal to increase to a maximum amplitude while the frequency of the manipulation signal evolves from the sum of the transition frequency and the initial detuning to the transition frequency (e.g., the sum of the transition frequency and a zero detuning). The controller 30 continues to control operation of the one or more manipulation sources 64 to cause the amplitude of the manipulation signal to decrease from the maximum amplitude to a final (approximately zero) amplitude and the frequency of the manipulation signal to evolve from the transition frequency to the sum of the transition frequency and the final detuning. In an example embodiment, the initial detuning of the deshelving operation is equal to the initial detuning of the shelving operation and the final detuning of the deshelving operation is equal to the final detuning of the shelving operation. In an example embodiment, the initial detuning of the deshelving operation is equal to the final detuning of the shelving operation and the final detuning of the deshelving operation is equal to the initial detuning of the shelving operation.

In various embodiments, the evolution of the amplitude of the manipulation signal and the frequency characterizing the manipulation signal used to perform the deshelving operation is performed slowly with respect to the Rabi frequency of the deshelving transition (which is the opposite of the shelving transition, in an example embodiment) and the frequency splitting of the Zeeman states of the first and second sub-spaces. For example, the time required to increase the amplitude of the manipulation signal from the initial (approximately zero) amplitude to the maximum amplitude may be longer than the inverse of the Rabi frequency of the deshelving transition. Similarly, the time required to decrease the amplitude of the manipulation signal from the maximum amplitude to the final (approximately zero) amplitude may be longer than the inverse of the Rabi frequency of the deshelving transition.

In various embodiments, the shelving operation (and/or deshelving operation) are performed as part of a quantum circuit and/or quantum program. In various embodiments, after completing the shelving operation and/or after completing the deshelving operation, the controller 30 may control various components of the atomic system and/or quantum computer to continue execution and/or performance of a quantum circuit and/or quantum program.

### Technical Advantages

Conventional shelving/deshelving techniques include applying a laser beam to a quantum object to shelve or deshelve the quantum object using a Rabi flop. However, driving the shelving transitions using a Rabi flop is complicated. For example, for a first sub-space including qubit states F=1, m=0 and F=2, m=0, it may be desired to shelve to the second sub-space including states F=2, m=1 and F=1, m=1. For example, the F=1, m=0 qubit state may be shelved to the F=2, m=1 state and the F=2, m=0 qubit state may be shelved to the F=1, m =1 state. However, the frequency difference between the F=1, m=0 qubit state and the F=2, m=1 state is sufficiently similar to the frequency difference between the F=2, m=0 qubit state and the F=1, m=1 state that both of the transitions can be driven with a single laser or microwave tone. The length of time for which the single laser or microwave tone is applied to cause a near 100% population inversion via the Rabi flop is the inverse of the Rabi frequency of the transition. However, the Rabi frequencies of the two transitions are different by a factor of an irrational number. Therefore, the shelving transitions cannot be performed with near 100% probability for both pairs of states. Thus, the probability of performing a complete shelving of both qubit states is not high enough for the performance of high-fidelity quantum logic gate, for example. As such, technical problems exist regarding the shelving and deshelving of quantum objects.

Various embodiments provide technical solutions to these technical problems. For example, various embodiments use an adiabatic rapid passage (ARP) to perform a shelving or deshelving operation. An ARP-based shelving operation allows for a complete (e.g., probability nearing 100%) shelving of both states of the first sub-space. To perform the ARP-based shelving operation, a manipulation signal (e.g., a microwave or laser pulse) is slowly turned on from zero-amplitude with the frequency characterizing the manipulation signal being detuned from the shelving transition(s) by an initial (non-zero) detuning. The amplitude of the manipulation signal is increased from zero amplitude to a maximum amplitude. As the amplitude is increased, the frequency characterizing the manipulation signal is evolved such that the frequency characterizing the manipulation signal is resonant with the shelving transition(s) when the amplitude of the manipulation signal is at the maximum amplitude. The amplitude of the manipulation signal is then decreased from the maximum amplitude to zero amplitude while the frequency characterizing the manipulation signal continues to evolve. When the amplitude of the manipulation signal reaches zero amplitude, the frequency characterizing the manipulation signal is at a final detuning from the shelving transition(s). In an example embodiment, the initial detuning and the final detuning have substantially the same magnitude and opposite signs.

In various embodiments, the process is performed slowly compared to the Rabi frequencies of the shelving transitions and the frequency splitting of the Zeeman states of the first and second sub-spaces. For example, the time required to increase the amplitude of the manipulation signal from zero amplitude to the maximum amplitude may be longer than the inverses of the Rabi frequencies of the shelving transitions. Similarly, the time required to decrease the amplitude of the manipulation signal from the maximum amplitude to zero amplitude may be longer than the inverses of the Rabi frequencies of the shelving transitions.

The slow amplitude and frequency changes of the manipulation signal enable the transition to be driven with a high likelihood of success (e.g., a probability that is independent of the coupling strength of the transition) while (coherently) maintaining the quantum information stored by the qubits. Thus, embodiments provide technical improvements and technical advantages to the fields of quantum object shelving (and/or deshelving) and atomic systems and/or quantum computers that use shelving (and/or deshelving) operations.

Moreover, conventional shelving (and/or deshelving) operations user laser beams and/or pulses to perform the Rabi flop. However, photons from the laser beam and/or pulse may be scattered off of the quantum object and/or the surface of the confinement apparatus. These scattered photons may be incident on other quantum objects, resulting in additional noise in the system. Various embodiments provide technical solutions to this technical problem by using a microwave signal as the manipulation signal. For example, an integrated circuit formed on the same substrate as the confinement apparatus or another substate that is secured with respect to the confinement apparatus may be operated (e.g., via application of current/voltage thereto by a voltage source 50, which is controlled by the controller 30) to generate the manipulation signal. As the manipulation signal in such embodiments is a microwave, photon scattering is significantly decreased compared to the case where a laser beam or pulse is used as the manipulation signal. Additionally, use of a microwave signal as the manipulation signal also significantly decreases the phase noise applied to the quantum object as a result of the shelving operation, compared to when a laser beam or pulse is used as the manipulation signal. Furthermore, the local generation of the manipulation signal means the manipulation signal can be generated at lower power as loss between generation of the manipulation signal and application of the manipulation signal at the target location 125 is very small. Thus, various embodiments provide multiple technical advantages.

### Example Computing Entity

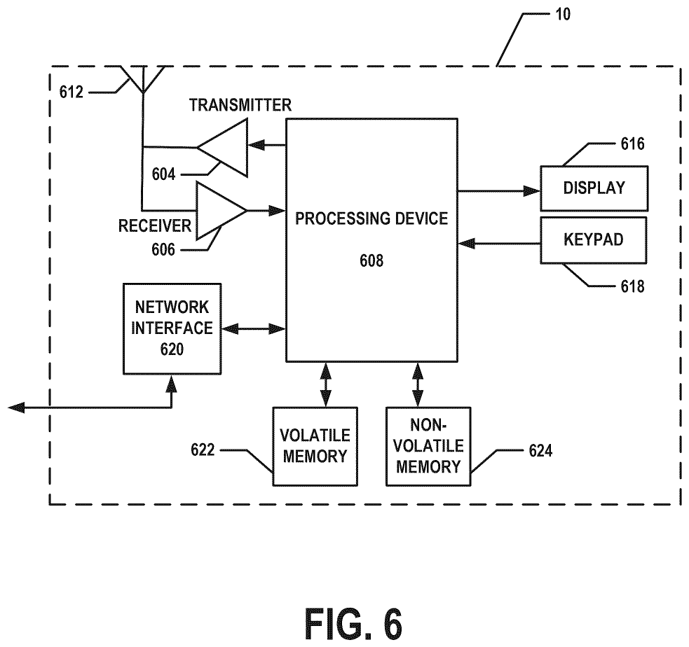

FIG. 6 provides an illustrative schematic representative of an example computing entity 10 that can be used in conjunction with embodiments of the present invention. In various embodiments, a computing entity 10 is configured to allow a user to provide input to the quantum computer 110 (e.g., via a user interface of the computing entity 10) and receive, display, analyze, and/or the like output from the quantum computer 110.

As shown in FIG. 6, a computing entity 10 can include an antenna 612, a transmitter 604 (e.g., radio), a receiver 606 (e.g., radio), and a processing device 608 that provides signals to and receives signals from the transmitter 604 and receiver 606, respectively. The signals provided to and received from the transmitter 604 and the receiver 606, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1 xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system. In various embodiments, the computing entity 10 comprises a network interface 620 configured to communicate via one or more wired and/or wireless networks 20.

In various embodiments, the processing device 608 may comprise processing elements, programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. The term circuitry may refer to an entirely hardware embodiment or a combination of hardware and computer program products.

The computing entity 10 may also comprise a user interface device comprising one or more user input/output interfaces (e.g., a display 616 and/or speaker/speaker driver coupled to a processing device 608 and a touch screen, keyboard, mouse, and/or microphone coupled to a processing device 608). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 618 (hard or soft), a touch display, voice/speech or motion interfaces, scanners, readers, or other input device. In embodiments including a keypad 618, the keypad 618 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 622 and/or non-volatile storage or memory 624, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### Conclusion

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of performing a shelving operation, the method comprising:
causing a manipulation source to provide a manipulation signal characterized by a frequency and an amplitude, wherein the frequency is detuned by a detuning from a transition frequency corresponding to a transition between a first quantum state of a quantum object and a second quantum state of the quantum object, the detuning being an initial detuning and the amplitude being an initial amplitude, and the manipulation signal is caused to be incident on the quantum object;
controlling operation of the manipulation source to cause the detuning of the manipulation signal to evolve from the initial detuning to a zero detuning such that the frequency characterizing the manipulation signal is equal to the transition frequency and, simultaneously, to cause the amplitude to increase from the initial amplitude to a maximum amplitude; and
controlling operation of the manipulation source to cause the detuning of the manipulation signal to evolve from the zero detuning to a final detuning and, simultaneously, to cause the amplitude to decrease from the maximum amplitude to a final amplitude.

2. The method of claim 1, wherein the initial detuning and the final detuning have opposite signs.

3. The method of claim 1, wherein the frequency is a microwave frequency.

4. The method of claim 1, wherein a time period over which the detuning is evolved from the initial detuning to the zero detuning and the amplitude is increased from the initial amplitude to the maximum amplitude is longer than an inverse of a Rabi frequency of the transition.

5. The method of claim 1, wherein the detuning is evolved from the initial detuning to the zero detuning and the amplitude is increased from the initial amplitude to the maximum amplitude adiabatically.

6. The method of claim 1, wherein a time period over which the detuning is evolved from the zero detuning to the final detuning and the amplitude is decreased from the maximum amplitude to the final amplitude is longer than an inverse of a Rabi frequency of the transition.

7. The method of claim 1, wherein the detuning is evolved from the zero detuning to the final detuning and the amplitude is decreased from the maximum amplitude to the final amplitude adiabatically.

8. The method of claim 1, wherein one of the first quantum state or the second quantum state is a magnetic field insensitive state and the other of the first quantum state or the second quantum state is a magnetic field sensitive state.

9. The method of claim 1, further comprising, after the amplitude of the manipulation signal is decreased to the final amplitude, causing performance of a magnetic field sensitive operation on the quantum object.

10. The method of claim 9, further comprising, after performance of the magnetic field sensitive operation on the quantum object, performing a deshelving operation on the quantum object.

11. The method of claim 10, wherein performing the deshelving operation comprises:
causing the manipulation source to provide the manipulation signal with the initial amplitude and one of the initial detuning or the final detuning;
controlling operation of the manipulation source to cause the detuning of the manipulation signal to evolve from the one of the initial detuning or the final detuning to the zero detuning such that the frequency characterizing the manipulation signal is equal to the transition frequency and, simultaneously, to cause the amplitude to increase from the initial amplitude to the maximum amplitude; and
controlling operation of the manipulation source to cause the detuning of the manipulation signal to evolve from the zero detuning to the other of the initial detuning or the final detuning and, simultaneously, to cause the amplitude to decrease from the maximum amplitude to the final amplitude.

12. The method of claim 1, wherein the initial amplitude and the final amplitude are substantially equal to zero.

13. A system comprising:
a confinement apparatus configured to confine one or more quantum objects at one or more target locations;
one or more manipulation sources configured to generate and provide respective manipulation signals to respective ones of the one or more target locations; and
a controller configured to control operation of the confinement apparatus and the one or more manipulation sources, the controller configured to:
cause a manipulation source of the one or more manipulation sources to provide a manipulation signal characterized by a frequency and an amplitude, wherein the frequency is detuned by a detuning from a transition frequency corresponding to a transition between a first quantum state of a quantum object of the one or more quantum objects and a second quantum state of the quantum object, the detuning being an initial detuning and the amplitude being an initial amplitude, and the manipulation signal is caused to be incident on the quantum object;
control operation of the manipulation source to cause the detuning of the manipulation signal to evolve from the initial detuning to a zero detuning such that the frequency characterizing the manipulation signal is equal to the transition frequency and, simultaneously, to cause the amplitude to increase from the initial amplitude to a maximum amplitude; and
control operation of the manipulation source to cause the detuning of the manipulation signal to evolve from the zero detuning to a final detuning and, simultaneously, to cause the amplitude to decrease from the maximum amplitude to a final amplitude.

14. The system of claim 13, wherein the manipulation source is one of a laser or an integrated circuit configured to generate a microwave signal.

15. The system of claim 13, wherein the initial detuning and the final detuning have opposite signs.

16. The system of claim 13, wherein the detuning is evolved from the initial detuning to the zero detuning and the amplitude is increased from the initial amplitude to the maximum amplitude adiabatically.

17. The system of claim 13, wherein the detuning is evolved from the zero detuning to the final detuning and the amplitude is decreased from the maximum amplitude to the final amplitude adiabatically.

18. The system of claim 13, wherein one of the first quantum state or the second quantum state is a magnetic field insensitive state and the other of the first quantum state or the second quantum state is a magnetic field sensitive state.

19. The system of claim 13, further comprising, after the amplitude of the manipulation signal is decreased to the final amplitude, causing performance of a magnetic field sensitive operation on the quantum object.

20. The system of claim 19, further comprising, after performance of the magnetic field sensitive operation on the quantum object, performing a deshelving operation on the quantum object.
